(19) United States
(12) Patent Application Publication
(10) Pub. No.: US 2008/0310935 A1
(43) Pub. Date: Dec. 18, 2008

(54) CUTTING APPARATUS AND CUTTING METHOD

(75) Inventors: Hiroki Hommochi, Moriya-shi (JP); Toshiaki Nochi, Joso-shi (JP)

Correspondence Address: FITZPATRICK CELLA HARPER & SCINTO, 30 ROCKEFELLER PLAZA, NEW YORK, NY, 10112, US

(73) Assignee: CANON FINETECH INC., Misato-shi (JP)

(21) Appl. No.: 12/135,435

(22) Filed: Jun. 9, 2008

(30) Foreign Application Priority Data
Jun. 12, 2007 (JP) 2007-155168

(51) Int. Cl. B42B 9/00

(52) U.S. Cl. 412/1; 412/16; 270/58.07; 270/1.01

(57) ABSTRACT

A cutting apparatus for cutting a book bundle has: a book bundle rotating mechanism for rotating the book bundle and changing a cutting surface; a book bundle moving mechanism for moving the book bundle in the direction of a cutting mechanism; and the cutting mechanism for separately cutting the cutting surface of the book bundle a plurality of times and not continuously cutting the same surface excluding the cutting surface to be finally cut for the book bundle to be cut.

### BACKGROUND OF THE INVENTION

1. Field of the Invention

The present invention relates to a cutting apparatus and a cutting method for cutting, for example, a book bundle in a state where one side of a sheet bundle has been bound and, more particularly, to a cutting apparatus and a cutting method for executing a cutting a predetermined portion of a book bundle set onto a predetermined table.

2. Description of the Related Art

Generally, in such a kind of cutting apparatus, in order to realize a miniaturization and a low price, an apparatus main body comprises one cutting unit and a rotating unit for holding a book bundle in association with the cutting unit and rotating the book bundle so as to face the cutting unit.

In a cutting apparatus, when three surfaces (surfaces other than a glue-coated adhesive surface) are cut, the book bundle is rotated and the three surfaces cut by the one cutting unit. A maximum cutting amount has been predetermined because there is a limit in a space adapted to process cut wastepaper in order to miniaturize the apparatus.

Japanese Patent Application Laid-Open No. 2005-161448, for example, discloses a technique for enabling the cutting of the predetermined cutting amount or more even in the cutting apparatus whose maximum cutting amount has been predetermined as mentioned above. The cutting apparatus disclosed in such a Patent Document is constructed in such a manner that in the case of cutting the surfaces by an amount over the maximum cutting amount, the same surface is divided and cut.

### SUMMARY OF THE INVENTION

However, in the foregoing cutting apparatus in the related art, in the case of cutting the three surfaces by an amount over the maximum cutting amount, for example, the cutting surface on the top side (top portion) is separately cut twice and, subsequently, the cutting surface on the foot side (foot portion) is separately cut twice. Finally, the cutting apparatus separately cuts the cutting surface on the fore-edge side (fore-edge surface) twice.

Therefore, when the same surface is continuously cut, a rotational center of a table which holds the book bundle is deviated from a position of the center of gravity of the held book bundle. Thus, if the book bundle is rotated so as to subsequently cut another surface, an angular moment is liable to act at the time of the rotation and rotation precision of the book bundle deteriorates. There is, consequently, a problem that precision of the cutting position deteriorates.

The invention is made by considering the foregoing problem and it is an object of the invention to provide a cutting apparatus and a cutting method which can improve precision of a cutting position for a book bundle.

To solve the above problem, according to the invention, there is provided a cutting apparatus comprising: a book bundle rotating mechanism which rotates the book bundle and changes a cutting surface; a book bundle moving mechanism which moves the book bundle in a direction of a cutting mechanism; and the cutting mechanism which separately cuts the cutting surface of the book bundle a plurality of times and does not continuously cut a same surface excluding the cutting surface to be finally cut for the book bundle to be cut.

In the cutting apparatus having the construction as mentioned above, for example, when executing the cutting by an amount over a predetermined cutting amount to the book bundle held by the book bundle rotating mechanism, the same cutting surface excluding the cutting surface to be finally cut is not continuously cut. Therefore, a rotational center of the book bundle held by the book bundle rotating mechanism is not extremely deviated from a position of the center of gravity of the book bundle and rotation precision of the book bundle is assured. Thus, precision of the cutting position can be held. In this case, as for the cutting surface which is finally cut, since it is unnecessary to rotate the book bundle after the cutting, the cutting process can be continuously executed two or more times or may be executed once.

Particularly, in the case of cutting the cutting surface by an amount over a maximum cutting amount for the book bundle of the cutting apparatus, it is desirable to separately cut the same cutting surface a plurality of times without continuously cutting the same cutting surface among a plurality of cutting surfaces. In the case of cutting the top portion and the foot portion of the book bundle, for example, it is desirable to alternately cut the top portion and the foot portion.

The foregoing cutting apparatus may be assembled into a bookbinding apparatus for aligning printed sheets into a bundle form, binding a front cover, and coating one side surface (rear portion) with glue or the bookbinding apparatus may be juxtaposed with an image forming apparatus for printing images onto sheets.

According to the invention, in order to solve the foregoing problems, there is provided a cutting method of a book bundle, whereby when a top portion and a foot portion of the book bundle whose front cover has been bound on one side are respectively cut a plurality of times, each of the top portion and the foot portion is not continuously cut.

According to such a cutting method, the same cutting surface is not continuously cut. Therefore, a rotational center of the book bundle held by the book bundle rotating mechanism is not extremely deviated from a position of the center of gravity of the book bundle and rotation precision of the book bundle is assured. Thus, precision of the cutting position can be held.

According to the invention, when a plurality of surfaces is cut for the book bundle, the same surface is not continuously cut. Therefore, the rotational center of the book bundle is not extremely deviated from the position of the center of gravity of the book bundle and the rotation precision of the book bundle is assured. Thus, precision of the cutting position can be held.

Further features of the present invention will become apparent from the following description of exemplary embodiments with reference to the attached drawings.

### BRIEF DESCRIPTION OF THE DRAWINGS

FIG. 1 is a diagram illustrating a whole construction of an image forming system in which a cutting apparatus of the invention has been assembled.

FIG. 2 is a diagram illustrating a construction of a bookbinding apparatus in the image forming system illustrated in FIG. 1.

FIG. 3 is a diagram illustrating a construction of a cutting unit in the bookbinding apparatus.

FIG. 4 is a plan view of the cutting unit illustrated in FIG. 3.

FIG. 5A is a diagram illustrating a cutting procedure of a sheet bundle in the cutting unit and is a perspective view illustrating a cutting state of a top portion.

FIG. 5B is a diagram illustrating the cutting procedure of the sheet bundle in the cutting unit and is a perspective view illustrating a cutting state of a foot portion.

FIG. 5C is a perspective view illustrating the cutting procedure of the sheet bundle in the cutting unit and is a perspective view illustrating a cutting state of a fore-edge foot portion.

FIG. 6A is a diagram illustrating a state of a home position in a cutting state of a cutting blade.

FIG. 6B is a diagram illustrating a state of a cutting position in the cutting state of the cutting blade.

FIG. 6C is a diagram illustrating a state of a sheet at the cutting position in the cutting state of the cutting blade.

FIG. 7A is a diagram illustrating a construction of the cutting blade.

FIG. 7B is a diagram illustrating an operating state of a cam groove.

FIG. 8A is a diagram illustrating a standby state in a construction of a cutting edge pressing mechanism.

FIG. 8B is a diagram illustrating a pressure-contact state in the construction of the cutting edge pressing mechanism.

FIGS. 9A, 9B, 9C, 9D, 9E and 9F are diagrams for describing a procedure for cutting the same surface of a sheet bundle a plurality of times.

### DESCRIPTION OF THE EMBODIMENTS

An embodiment of a cutting apparatus and a cutting method according to the invention will be specifically described hereinbelow with reference to the drawings.

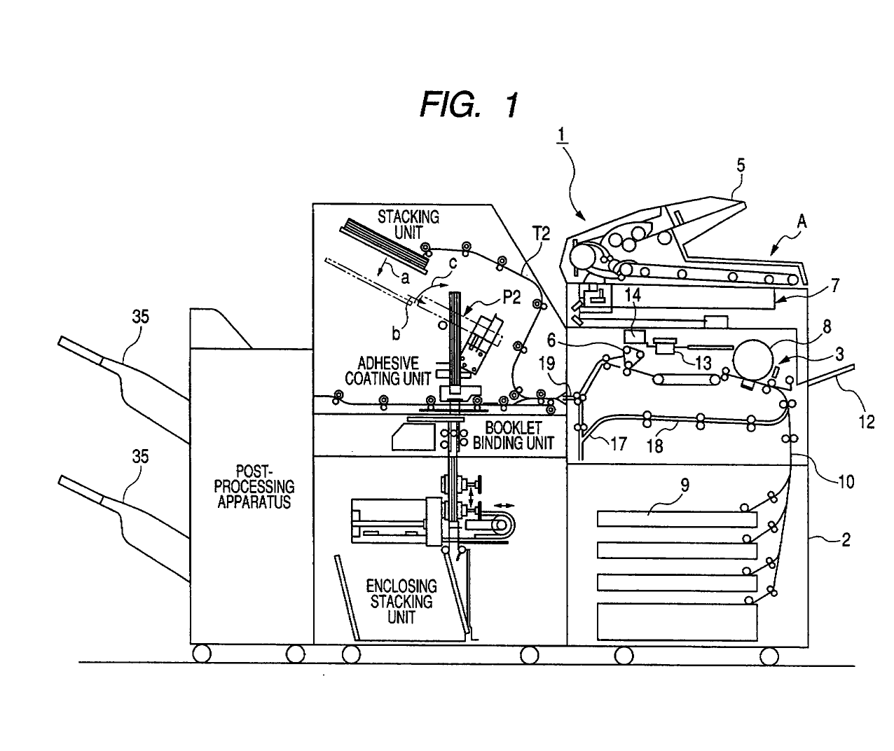

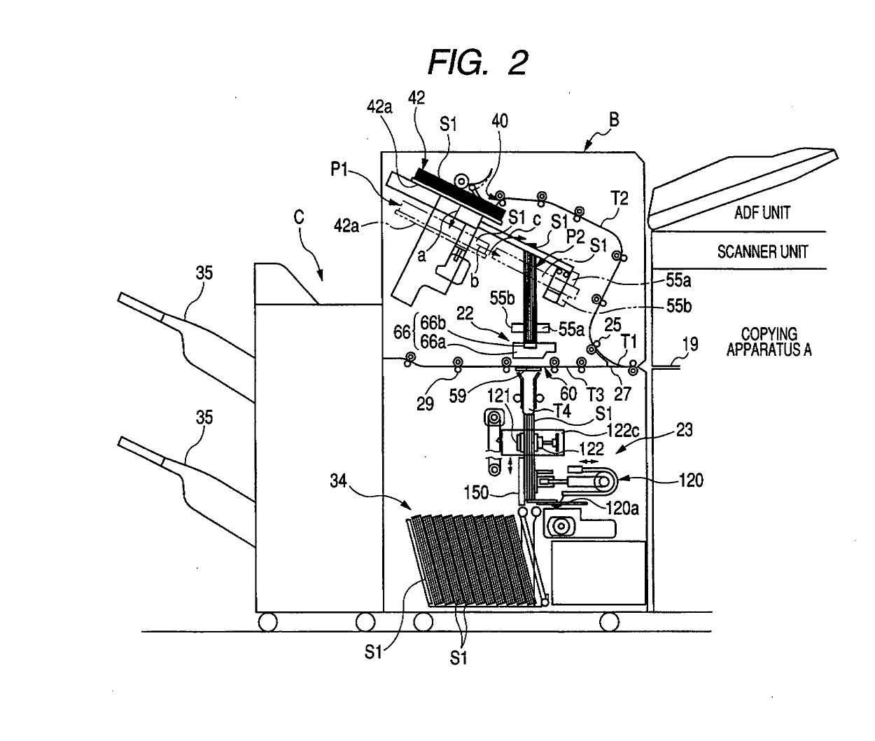

FIG. 1 illustrates a whole construction of an image forming system in which the cutting apparatus according to the invention has been assembled. FIG. 2 illustrates a construction of a bookbinding apparatus in the image forming system illustrated in FIG. 1.

The image forming system illustrated in FIG. 1 has: an image forming apparatus (a copying apparatus is illustrated in the diagram) A; a bookbinding apparatus (bookbinding unit) B juxtaposed with the image forming apparatus; and a post-processing apparatus (post-processing unit) C arranged on a downstream side of the bookbinding apparatus B. A cutting apparatus according to the invention has been built as a unit in the bookbinding apparatus B. The bookbinding apparatus B receives sheets from a sheet discharge port 19 of the image forming apparatus A, stacks a series of documents into a bundle form, coats one side surface (rear portion) of the bundle-shaped sheets with glue, and binds with a front cover sheet. Subsequently, a peripheral edge of the sheets which have been bound in a pamphlet form is cut by a predetermined amount and the resultant sheets are stacked onto an enclosing stacker. The post-processing apparatus C is juxtaposed with the bookbinding apparatus and is constructed in such a manner that, the sheets which are not bookbinding-processed are received and post-processes such staple binding, punch (punching process), and stamp (stamping process) are executed. The post-processing apparatus (not shown) has a sheet discharge stacker for enclosing the sheets on which images have been formed by the image forming apparatus A.

The image forming apparatus A is constructed as a copying apparatus having: an image forming unit 3 provided in a main body apparatus 2; an image reading apparatus (scanner unit) 7 arranged in an upper portion of the main body apparatus 2; and an automatic document feeder (ADF unit) 5. The image forming unit 3 is provided for the main body apparatus 2 and forms an image onto a sheet such as plain paper, or OHP sheet which is supplied from a sheet feeding unit 9. For example, the image forming unit 3 forms an electrostatic latent image onto a photosensitive drum 8 by a light irradiating mechanism 13. Toner is deposited onto the sheet and transferred onto the sheet by a developing apparatus. The sheet is fixed by a fixing unit 6 and ejected from the sheet discharge port 19. In a duplex printing mode, obverse/reverse sides of the sheet in which the image has been printed on one surface are reversed by a switchback path 17. The reversed sheet is sent again from a circulating path 18 to the photosensitive drum 8, an image is printed onto the reverse side, and the sheet is ejected from the sheet discharge port 19. In the diagram, for example, thick paper such as a front cover sheet or a special sheet such as a coating sheet is supplied from a manual feeding port 12.

The image reading apparatus (scanner unit) 7 is arranged over the main body apparatus 2 constructed as mentioned above. In the image reading apparatus 7, an original document set on a platen is scanned by a photoelectric converting element and obtained image data is transferred to a data storing unit 14 of the main body apparatus 2. Further, the automatic document feeder (ADF unit) 5 for automatically feeding the original onto the platen is provided for the image reading apparatus 7. The ADF 5 separates the originals set on a sheet feeding tray one by one and automatically feeds the separated original to the platen. Such an image forming apparatus is widely used and the image forming apparatuses having various structures have been known. The invention is not limited to the electrostatic printing system illustrated in the diagrams but another system such as screen printing system, or ink-jet printing system can be used.

The bookbinding apparatus B is juxtaposed at the sheet discharge port of the foregoing image forming apparatus A. The bookbinding apparatus B has: a stacking unit 42 for stacking and enclosing sheets S in a bundle form; an adhesive coating unit 22; a front cover adhering unit 60; a cutting unit 23; and an enclosing stacking unit 34. The bookbinding apparatus B receives the image-formed sheets from a sheet feed-in path T1 communicated with the sheet discharge port 19 of the image forming apparatus A. In the bookbinding apparatus B, a series of sheets is stacked in a bundle form and aligned by the stacking unit 42, thereafter, one side edge of the bundle-shaped sheets is coated with glue in the adhesive coating unit 22, and the sheets are bound integratedly with the front cover sheet by the front cover adhering unit 60. A sheet binding mechanism is constructed by the adhesive coating unit 22 and the front cover adhering unit 60. After that, a series of bookbinding processes for cutting a peripheral edge of the pamphlet-shaped sheets and finishing is executed in the cutting unit 23. Particularly, according to the apparatus illustrated in the diagram, in the stacking unit 42, the stacking and alignment of the sheets are executed in an almost horizontal posture and the sheet bundle is rotated by 90° and coated with glue in an almost vertical posture. The present apparatus is characterized in that the process for binding with the front cover sheet and the process for cutting and aligning the sheet peripheral edges are sequentially executed in an almost vertical posture. Since the sheets are transported from the horizontal direction to the vertical direction as mentioned above, the apparatus is constructed in a compact size.

A conveying path T2 for guiding the sheets to the stacking unit and a conveying path T3 for guiding the sheets to the post-processing apparatus C are communicated with the foregoing sheet feed-in path T1 through a path change-over flapper 27 as illustrated in the diagram. The bookbinding apparatus having a construction in which the front cover sheet is supplied from the image forming apparatus (copying apparatus) A is illustrated in FIG. 2. It is also possible to use such a construction that an inserting apparatus for automatically feeding the front cover sheet to the sheet feed-in path T1 is provided and the front cover sheet is supplied from the inserting apparatus. Conveying rollers 25 and 29 are arranged on each path along which the sheet is conveyed.

The apparatus constructed as mentioned above can execute the processes in an ejecting mode, a bookbinding mode, and a bookbinding/cutting mode. The ejecting mode is such an ordinary process that the sheets from the image forming apparatus A are directly ejected onto a sheet discharge tray 35 of the post-processing apparatus C by the change-over flapper 27. The bookbinding mode is such a process that the sheets from the image forming apparatus A are fed from the sheet feed-in path T1 to the conveying path T2, coated with glue in the adhesive coating unit 22, book-bound, and finished in a non-cutting state. The bookbinding/cutting mode is such a process that the edge portion of the sheets after the bookbinding process is cut and aligned.

A stacking tray 42a for sequentially piling and stacking the sheets S is provided at a sheet discharge port 40 of the conveying path T2 of the bookbinding apparatus B and a series of sheets ejected from the image forming apparatus is formed in a bundle form. The stacking unit 42 is constructed by the stacking tray 42a. The stacking tray 42a illustrated in the diagram descends in the stacking direction of the sheets (direction shown by an arrow a in FIG. 1) by a vertical elevating mechanism according to a thickness of sheet bundle. The stacking tray 42a is inclined with respect to the horizontal direction. A restricting member for abutting and aligning a sheet rear edge is provided on a rear edge side of the sheet. An aligning mechanism for aligning a width direction of the sheets is provided for the stacking tray 42a. The aligning mechanism aligns the sheets ejected onto the tray in a direction which perpendicularly crosses a conveying direction based on a center reference in which the center is used as a reference or based on a side reference in which one side edge is used as a reference.

When the series of sheets is stacked onto the stacking tray 42a in an almost horizontal posture, the whole tray is moved to a first position P1 which has descended by a predetermined distance in the direction of the arrow a from the stacking position where the sheets are stacked. Subsequently, the sheet bundle is moved from the position P1 in the direction shown by an arrow b which perpendicularly crosses the direction of the arrow a and fed out to a second position P2. Grippers 55a and 55b for holding the edge portion of a sheet bundle S1 fed out of the stacking tray 42a are arranged at the second position P2. The grippers 55a and 55b deflect the sheet bundle from the horizontal posture to the almost vertical posture and convey to the adhesive coating unit 22 arranged on the downstream side. At the same time, a thickness position detecting sensor (not shown) for detecting a thickness of the grasped sheet bundle is provided.

The adhesive coating unit 22 has an adhering mechanism 66 constructed by: a glue container 66a for enclosing an adhesive (for example, glue); and a coating roller 66b for coating a side edge of the sheet bundle S1 with the adhesive contained in the glue container. The adhering mechanism 66 coats a lower edge of the sheet bundle in the almost vertical posture held by the grippers 55a and 55b with the adhesive such as a glue. The glue container 66a illustrated in the diagram is supported by a guide rail (not shown) by a path longer than a length size of the sheets so as to be movable in the obverse/reverse direction of the paper surface in FIG. 2. Therefore, the glue container 66a is movable among a coating area where it moves along the lower edge of the sheet bundle, a standby position on the outside of the coating area, and a supplementing position where the adhesive is supplemented.

The coating roller 66b for impregnating the glue such as heat resistant rubber is provided for the glue container 66a. The coating roller is rotated by a driving motor (not shown) and forms a small gap between the roller and the sheets when the glue container moves along the edge surface of the sheet bundle. By changing this gap according to the thickness of sheet bundle, a glue coating amount is adjusted.

When the adhering mechanism 66 is located at the standby position, a conveying path T4 of the sheet bundle S1 is assured and the glue-coated sheet bundle S1 is sent to the front cover adhering unit 60 by the grippers 55a and 55b.

The front cover adhering unit (front cover sheet binding unit) 60 is provided in a crossing portion of the conveying paths T3 and T4. The front cover adhering unit 60 is prepared so that the front cover sheet is conveyed to the conveying path T3 and the sheet center is located in the crossing portion. The front cover sheet and the sheet bundle are aligned and joined so that the sheet bundle coincides with the center of the front cover sheet (sheet center) in a reverse T-character shape. Upon joining, a backup plate 59 is prepared for the conveying path T3. As a case of feeding the front cover sheet, there are a case where, for example, a title is printed onto the front cover sheet and the sheet is supplied from the image forming apparatus and a case where the front cover sheet is supplied from an inserter apparatus provided for the sheet feed-in path T1. To the front cover sheet which has been positioned as mentioned above and supported by the backup plate 59, the edge of the sheet bundle S1 coated with the adhesive is pressed in the vertical direction from the upper side by the grippers 55a and 55b. After that, the front cover sheet and the sheet bundle S1 are pressed from both sides by a slidable back folding plate in a state where they have abutted on the backup plate 59. Thus, a crease (rear portion) according to the thickness of sheet bundle S1 is formed in the front cover.

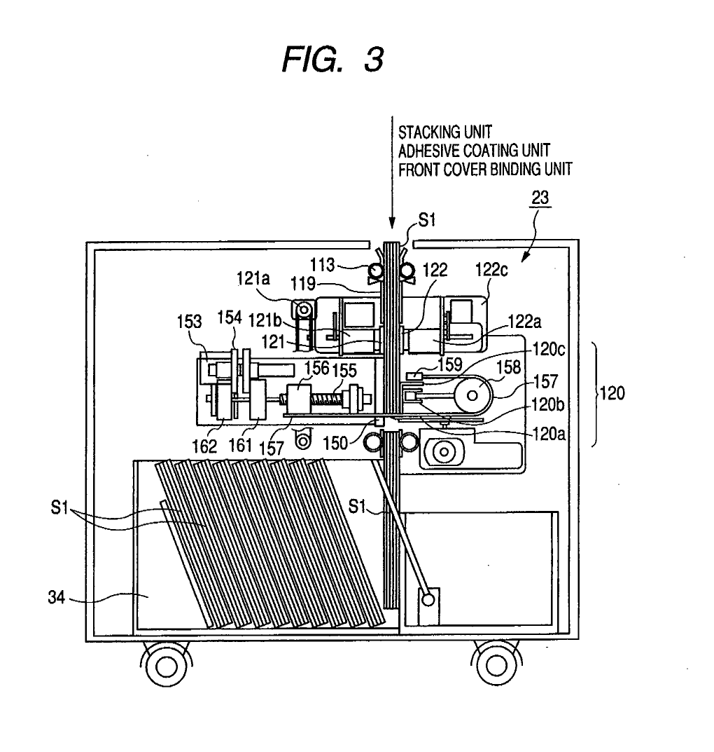

Subsequently, when the backup plate 59 moves from the conveying path T4 to the outside and refuges, the sheet bundle grippers 55a and 55b hand the front cover adhered sheet bundle S1 to the lower cutting unit 23 in a state where the sheet bundle S1 is sandwiched. A pair of feed-in rollers 113 (refer to FIG. 3) as folding rollers are provided for the cutting unit. The feed-in rollers 113 take over the sheet bundle (hereinbelow, referred to as pamphlet-shaped sheets) conveyed from the grippers 55a and 55b and convey it to the sheet cutting unit 23 on the downstream side. Simultaneously with the conveyance, the feed-in rollers 113 fold the sheet bundle to the front cover sheet so as to be aligned.

The cutting unit 23 for cutting a predetermined position of the sheet bundle S1 supplied from the front cover adhering unit 60 and the conveying path T4 for conveying the sheet bundle S1 to the enclosing stacking unit 34 are provided on the downstream of the feed-in rollers 113. While the conveying path T3 is arranged in an almost horizontal direction, the conveying path T4 is arranged in an almost vertical direction by a pair of conveying guides 119.

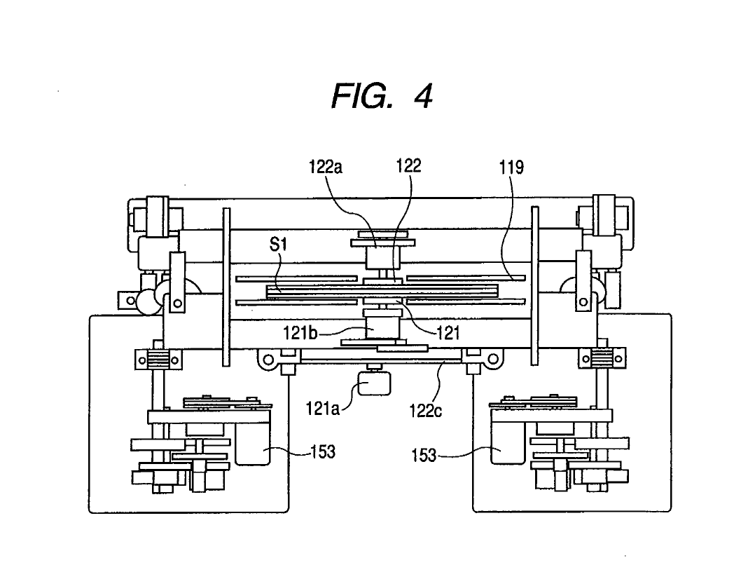

Subsequently, a construction of the cutting unit 23 will be described with reference to FIGS. 3 to 8B.

The cutting unit 23 has: a book bundle rotating mechanism for rotating the book bundle and changing a cutting surface; a book bundle moving mechanism for moving the book bundle in the direction of a cutting mechanism; and the cutting mechanism for cutting the edge portion of the book bundle.

The book bundle rotating mechanism is disposed on the conveying path T4 and has a cutting stage 120 constructed by, for example: a rotary table 121; and a gripper 122 for pressing the sheet onto the table 121 so as to sandwich it. The book bundle rotating mechanism operates so as to rotate the book bundle and change the cutting surface.

The rotary table 121 and the gripper 122 are arranged at positions where they face each other through the conveying guides 119. The rotary table 121 and the gripper 122 are constructed so as to be rotatable in a state where the sheet bundle has been grasped and are assembled in a unit frame 122c supported to an apparatus frame so as to freely ascend and descend. The rotary table 121 is constructed so that a disk-shaped member for supporting a sheet center portion can be rotated by a rotating motor 121b. The gripper 122 is arranged at a position where it faces the rotary table 121. The gripper 122 is supported by a gripper moving mechanism 122a having a gripper driving motor so that it can freely approach and be away from the rotary table 121 and is constructed so as to rotate in association with a rotation of the rotary table.

The book bundle moving mechanism moves the book bundle in the direction of the cutting mechanism. The book bundle moving mechanism has, for example: the unit frame 122c for supporting the rotary table 121 and the gripper 122 mentioned above; and an elevating mechanism 121a. The rotary table 121 and the gripper 122 are constructed so as to be movable in the vertical direction in FIG. 3 for the apparatus frame by the elevating mechanism 121a.

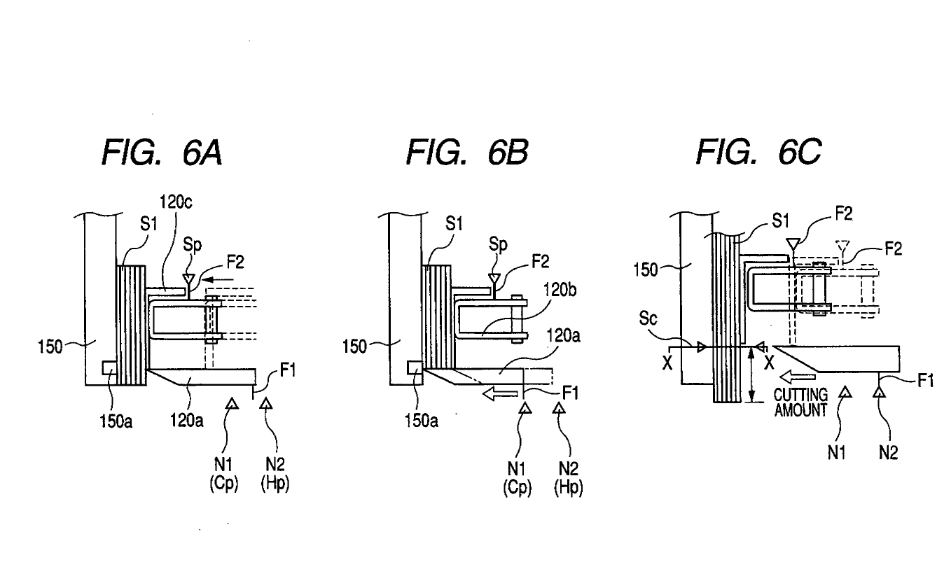

Therefore, the pamphlet-shaped sheets (book bundle) are sent from the feed-in rollers 113 to the conveying guides 119 and grasped by the rotary table 121 and the gripper 122. The pamphlet-shaped sheets are rotated in the vertical posture in FIG. 3 by the rotation of the rotary table 121 as a book bundle rotating mechanism. A predetermined position (top portion, foot portion, fore-edge portion) of the sheet bundle is made to face a cutting position X-X on the downstream side (refer to FIG. 6C). The pamphlet-shaped sheets are moved in the direction of the cutting mechanism by a predetermined amount by the elevating mechanism 121a as a book bundle moving mechanism. A sheet detecting sensor (not shown) for detecting the presence or absence of the sheets S1 is provided for the rotary table 121. A grip end sensor (not shown) for detecting the completion of the pressing operation by which the gripper moving mechanism 122a grasps the sheet bundle is provided for the gripper 122.

The cutting mechanism is disposed on the downstream side of the rotary table 121. The cutting mechanism has, for example, a cutting edge pressing mechanism (120b and 120c) and a cutting blade 120a and has a function for sandwiching and holding a cutting edge at the cutting position of the sheet and executing the cutting.

A blade receiving member 150 is provided at the cutting position (X-X shown in FIG. 6C). The flat-shaped cutting blade 120a faces the blade receiving member 150 and executes the cutting operation by a structure, which will be described hereinafter. The blade receiving member 150 is made by such a block member as to defeat a shearing force upon sheet cutting. A blade receiving plane 150a made of a soft material such as synthetic resin, rubber, or the like is provided on a surface of the blade receiving member 150. This is because after the sheet was cut, a tip collides with the blade receiving surface with great force and the tip is not damaged in this instance.

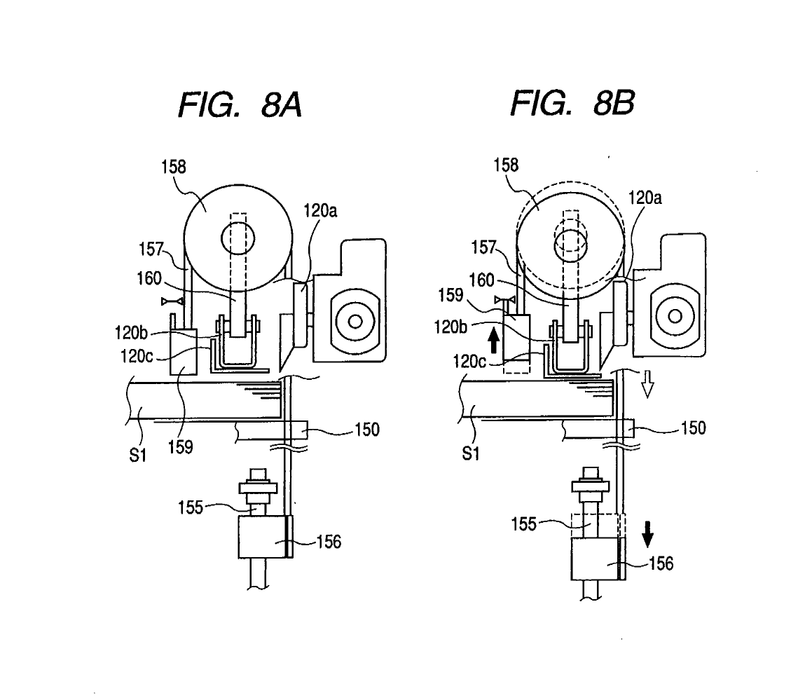

The cutting edge pressing mechanism (120b and 120c) for supporting the cutting edge of the sheet bundle illustrated in FIG. 8A with a pressure is arranged at positions where they face the blade receiving member 150. The cutting edge pressing mechanism has a pressing member 120c, a movable pressing plate 120b, and a pressing mechanism. The pressing member 120c which is come into contact with the sheets and presses them is made of a plate-shaped member which is come into contact with the whole length of the sheet in the cutting direction and is fixed to the movable pressing plate 120b. The movable pressing plate 120b is attached to the apparatus frame so as to be rotatable around a rotary axis (not shown) as a rotational center and be movable in the direction shown by an arrow in FIG. 8B. A pair of pressing mechanisms are provided for the movable pressing plate 120b at right and left positions in its longitudinal direction. The right and left pressing mechanisms have the same structure and each pressing mechanism has: a pressing motor 153; a deceleration transfer gear 154 coupled with the motor 153; a screw 155 coupled with the gear 154; a slider 156 which is in engagement with the ball screw 155; a belt 157 fixed to the slider 156; a movable pulley 158 around which the belt 157 has been suspended; and a pressing spring 159.

The movable pressing plate 120b is coupled with the movable pulley 158 through a pressing rod 160. The movable pulley 158 is supported to the apparatus frame so as to be movable in the direction of the arrow in FIG. 8B and has a structure of an ordinary running pulley. The pressing spring 159 is coupled with one end of the belt 157 suspended around the movable pulley 158. The other end of the belt 157 is fixed to the slider 156. Therefore, when the pressing motor 153 is driven and the ball screw 155 is rotated, the slider 156 is moved from the standby position away from the sheet bundle in FIG. 8A to the position where the sheet bundle is pressed in FIG. 8B.

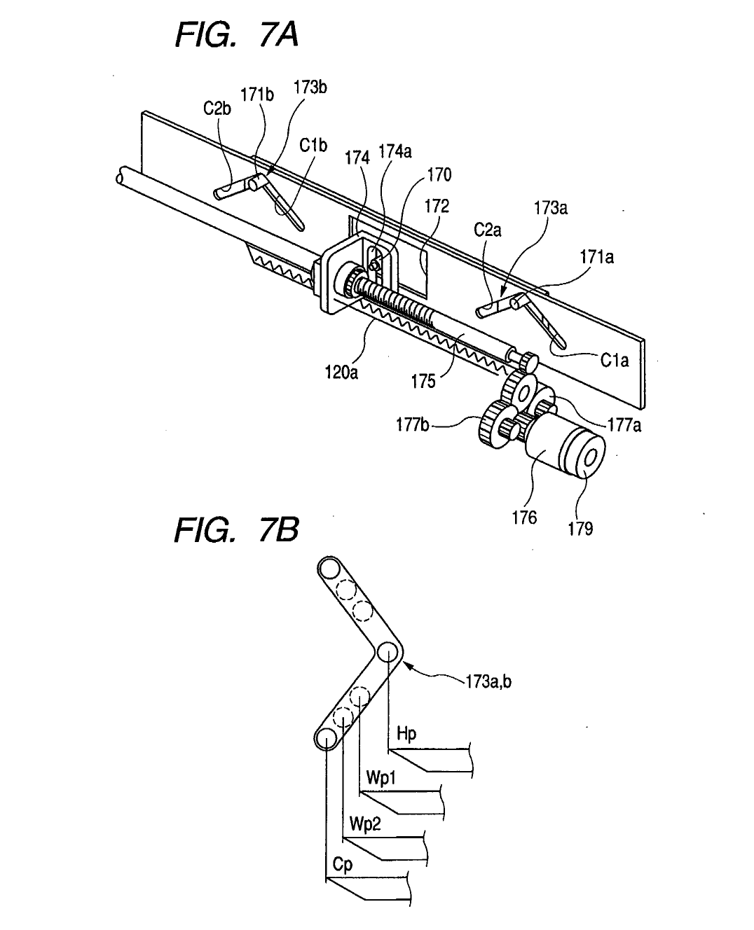

The cutting blade 120a is made by a flat-blade cutter. As illustrated in FIG. 3, the cutting blade 120a is arranged at the cutting position (X-X shown in FIG. 6C) on the downstream side of the rotary table 121 and is constructed so that it can freely reciprocate in the horizontal direction illustrated in the diagram. As illustrated in FIG. 7A, the cutting blade 120a is movable in the horizontal direction at the cutting position and is movably guided and supported to the apparatus frame. A guide pin 170 at a center and a pair of right and left cam pins 171a and 171b are planted onto the cutting blade 120a. The guide pin 170 is communicated into a clearance groove 172 of the frame. The cam pins 171a and 171b are in engagement with cam grooves 173a and 173b formed in the frame, respectively. An engaging groove 174a of a slide member 174 which moves to the right and left in the diagram is fitted to the guide pin 170. A ball screw (hereinbelow, referred to as a screw) 175 is fitted to the slide member 174. A cutter driving motor 176 formed by a DC motor which can rotate forwardly and reversely is coupled with the screw 175.

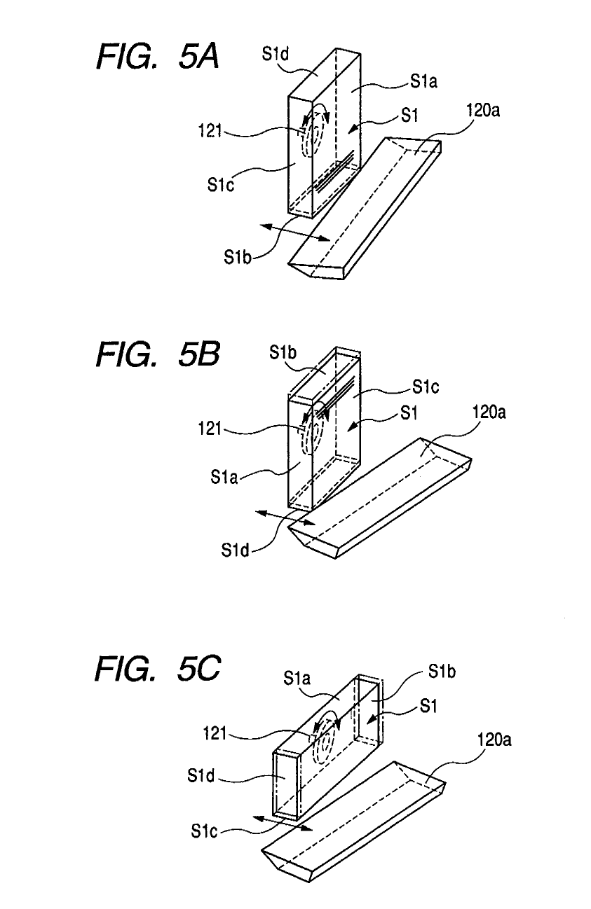

The cam pins 171a and 171b are planted onto the cutting blade 120a, form one pair of the right and left cam pins, are come into engagement with the cam grooves 173a and 173b, and are moved in the vertical direction illustrated in the diagram. Particularly, the cam groove 173a illustrated in the diagram has a right cam C1a and a left cam C2a arranged so that their inclination directions are made different. Similarly, the cam groove 173b illustrated in the diagram has a right cam C1b and a left cam C2b arranged so that their inclination directions are made different. When the cutting blade moves to the right, the right cams C1a and C1b guide the cam pins 171a and 171b, respectively. When the cutting blade moves to the left, the left cams C2a and C2b guide the cam pins 171a and 171b, respectively. Therefore, when the cutting blade moves to the right from the position illustrated in the diagram (the home position in FIG. 7A), the cutting blade descends while moving to the right along the right cams C1a and C1b and moves to the cutting position. Similarly, when the cutting blade moves to the left, the cutting blade descends gradually while moving to the left along the left cams C2a and C2b and moves to the cutting position. The right cams C1a and C1b and the left cams C2a and C2b which form the pairs of the right and left cams are arranged so that their inclination angles (phase differences) are made different, respectively. Therefore, when the cutting blade 120a moves to the right, it is inclined as illustrated in FIG. 5A and when the cutting blade 120a moves to the left, it is inclined as illustrated in FIG. 5C. Those cams set the cutting blade to the horizontal posture at a home position Hp and a cutting position Cp in FIG. 7B.

That is, when the cutting blade 120a moves to the right, it is inclined from the horizontal posture so that its right edge is gradually lowered, and the cutting blade descends gradually and reaches the cutting position in the horizontal posture. When the cutting blade 120a moves to the left, it also similarly operates. The reason why the cutting blade is inclined is that it can gradually cut the sheet bundle from one end to the other end of the sheet bundle. The reason why the right inclination and the left inclination are provided is that the cutting blade can cut from the rear portion of the glue-bound edge to the fore-edge portion. For example, it is because the top portion is cut by the right inclination and the foot portion is cut by the left inclination. Since the sheet bundle is cut from the glue-bound rear portion toward the fore-edge portion on the opposite side as mentioned above, the rear portion (glue binding portion) in which a load is the largest is cut first and a frictional load of the cut sheet edge surface which is applied to a side portion of the blade can be received in the fore-edge portion in which a load is relatively small. That is, since the cutting blade is inclined toward the cutting direction and gradually cuts the sheet bundle, the cutting load is minimized and the miniaturization and light weight of the apparatus are accomplished.

The right cams C1a and C1b and the left cams C2a and C2b incline the cutting blade 120a in the opposite directions, respectively. The inclination angles on the right and left sides to the sheets are equal and are set to a proper angle such as 30° or the like based on experiments.

As illustrated in FIGS. 5A to 5C, 7A, and 7B, the cutting blade 120a constructed as mentioned above executes the following cutting operation as a fundamental operation to the bookbinding sheet bundle (book bundle).

(1) Cutting of Top Portion

First, when the apparatus is activated, the cutting blade 120a is located at the home position Hp away from the sheet surface (in FIG. 6C, the position where the tip of the cutting blade is slightly away from the sheet bundle surface). The home position is recognized by a method whereby a sensor N2 detects a flag F1 formed on the cutting blade. The cutter driving motor 176 is rotated at timing when the sheet bundle is fed in by the feed-in rollers 113, thereby moving the cutting blade 120a to the cutting position Cp along the right cams C1a and C1b. When a position sensor N1 detects that the cutting blade 120a has reached the cutting position, the cutting blade 120a is stopped. In this state, a lower edge of the sheet bundle abuts on the cutting blade at the cutting position, the sheet bundle is positioned, and the foregoing rotary table 121 and gripper 122 grip the sheet bundle. When a grip end sensor provided for the gripper detects that the sheet bundle has completely been gripped, the cutter driving motor 176 is reversely rotated in response to its detection signal, so that the cutting blade is returned to a standby position Wp1 (Wp2).

Subsequently, the rotary table 121 and the gripper 122 rotate the sheet bundle by 90°, thereby setting a top portion S1b of the sheet bundle to the cutting position. The cutter driving motor 176 is again rotated in response to a signal indicative of the completion of the setting. The screw 175 is moved to the right in FIG. 7A, thereby moving the cutting blade along the right cams C1a and C1b. Thus, in the state of FIG. 5A, the cutting blade 120a first cuts a rear portion S1a, gradually cuts a fore-edge portion S1c side, progresses to the cutting position, and finishes the cutting (FIG. 6B). When the position sensor N1 detects that the cutting blade has reached the cutting position Cp, the motor is stopped. At the same time, the cutter driving motor 176 rotates reversely. When the position sensor N2 detects that the cutting blade 120a has been returned to the home position, the cutting blade 120a is stopped.

(2) Cutting of Foot Portion

In parallel with the return to the home position, the rotary table 121 and the gripper 122 rotate the sheet bundle by 180°, thereby setting a foot portion S1d into a state of FIG. 5B so as to face down. In the processes of the rotation of the sheet bundle and the setting to the cutting position, the motor 176 is rotated in the direction opposite to that mentioned above. The cutting blade 120a is moved to the standby position along the left cams C2a and C2b and stopped. The motor 176 is rotated in the same direction in response to the set completion signal showing that the sheet bundle has completely been set to the cutting position. Thus, the cutting blade 120a gradually cuts the fore-edge portion S1c from the rear portion S1a in the direction opposite to that mentioned above and reaches the cutting position. In a manner similar to that mentioned above, by reversely rotating the motor 176, the cutting blade is returned to the standby position.

(3) Cutting of Fore-Edge Portion

The rotary table 121 and the gripper 122 rotate the sheet bundle by 90°, thereby setting the fore-edge portion S1c into a state of FIG. 5C. Since the cutting blade in this instance may be inclined in any of the foregoing directions, the cutting blade cuts the sheet bundle along the left cams in a manner similar to the foot portion S1d just before. After completion of the cutting, the motor 176 is reversely rotated, thereby returning the cutting blade to the home position and stopping and holding it at this position. In this state, the cutting blade prepares for the cutting of the subsequent sheet bundle.

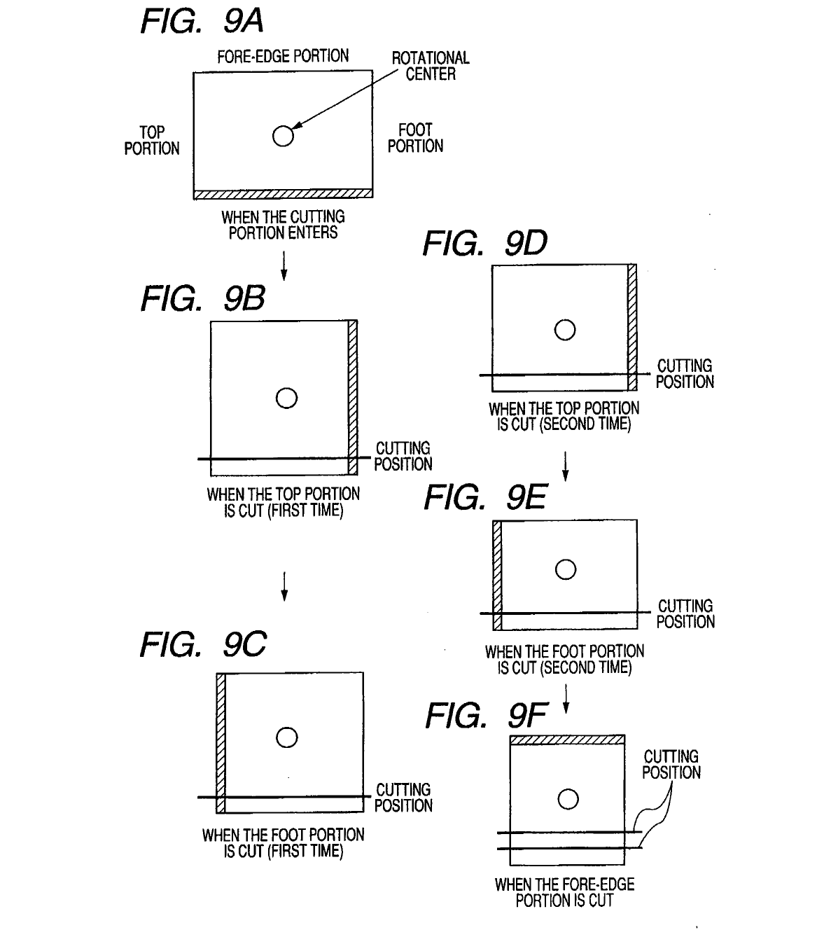

The cutting procedure has been described above with respect to the case where after the front cover was adhered to the sheet bundle, each of the top portion, foot portion, and fore-edge portion is cut once. A cutting procedure for cutting the same surface a plurality of times according to a feature of the invention will be described hereinbelow with reference to FIGS. 9A to 9F. A cutting procedure in the case where the actual cutting amount is larger than the maximum cutting amount (refer to FIG. 6C) which has been predetermined in the cutting apparatus of the invention will be described here. For example, a cutting procedure for cutting each surface portion (three directions of the top portion, foot portion, and fore-edge portion) twice will be described.

First, as illustrated in FIG. 9A, the sheet bundle is sent to the cutting apparatus in a state where its adhered rear portion (hatched region) faces down. At this time, almost the center of gravity of the sheet bundle is gripped by the foregoing rotary table 121 and gripper 122 and becomes a rotational center as illustrated in the diagram. At this time, in consideration of the precision of the cutting position upon cutting in three directions, the sheet bundle is gripped by the foregoing rotary table 121 and gripper 122 until the cutting in the three directions is finished.

FIG. 9B illustrates a state of the sheet bundle upon cutting of the top portion. After the sheet bundle was rotated counterclockwise by 90° from the state of FIG. 9A, the sheet bundle is moved in the vertical direction by a predetermined amount by the foregoing elevating mechanism 121a and set into a state of FIG. 9B. After that, the first cutting operation of the top portion is executed.

Since the cutting amount of the sheet bundle is large as mentioned above, the cutting mechanism separately cuts the top portion as a same surface a plurality of times. At this time, the cutting mechanism does not continuously cut the same surface. The foregoing book bundle rotating mechanism and book bundle moving mechanism are subsequently driven and controlled so as to cut the foot portion of the sheet bundle. Also with respect to the foot portion as a same surface, since the cutting amount of the sheet bundle is large, the cutting mechanism separately cuts the foot portion as a same surface a plurality of times. At this time, the cutting mechanism does not continuously cut the same surface. The foregoing book bundle rotating mechanism and book bundle moving mechanism are subsequently driven and controlled so as to cut the top portion of the sheet bundle. That is, in the case of cutting the top portion and the foot portion a plurality of times, respectively, the book bundle rotating mechanism and the book bundle moving mechanism are driven and controlled so as to alternately cut the top portion and the foot portion.

FIG. 9C illustrates a state of the sheet bundle upon cutting of the foot portion. The sheet bundle is rotated clockwise by 180° from the state of FIG. 9B and the sheet bundle is moved in the vertical direction by a predetermined amount by the foregoing elevating mechanism 121a and set into a state of FIG. 9C. After that, the first cutting operation of the foot portion is executed. If the cutting amounts of the top portion and the foot portion are set to be too large in the states of FIGS. 9B and 9C, upon rotation after the cutting, the rotational center of the book bundle is extremely deviated from the position of the center of gravity of the book bundle, the rotation precision deteriorates, and there is a case where the cutting position is deviated. Therefore, the cutting amount of the one time is set to such a value that the position of the book bundle is not deviated by an influence of an angular moment.

FIG. 9D illustrates a state of the sheet bundle at the time of the second cutting of the top portion. The sheet bundle is rotated counterclockwise by 180° from the state of FIG. 9C. The sheet bundle is moved in the vertical direction by a predetermined amount by the foregoing elevating mechanism 121a and set into a state of FIG. 9D. After that, the second cutting operation of the top portion is executed.

FIG. 9E illustrates a state of the sheet bundle at the time of the second cutting of the foot portion. The sheet bundle is rotated clockwise by 180° from the state of FIG. 9D. The sheet bundle is moved in the vertical direction by a predetermined amount by the foregoing elevating mechanism 121a and set into a state of FIG. 9E. After that, the second cutting operation of the foot portion is executed.

FIG. 9F illustrates a state of the sheet bundle upon cutting of the fore-edge portion. The sheet bundle is rotated clockwise by 90° from the state of FIG. 9E. The sheet bundle is moved in the vertical direction by a predetermined amount by the foregoing elevating mechanism 121a and the fore-edge portion is cut. In this case, the fore-edge portion is a cutting surface which is finally cut. After the fore-edge portion was cut, the rotation and the cutting operation of the sheet bundle are not executed. Therefore, the cutting operation of the fore-edge portion is continuously executed twice. Naturally, the fore-edge portion may be cut by one cutting operation.

By using the method whereby the same surface is not continuously cut twice like a foregoing cutting method, the rotational center of the sheet bundle is not deviated from the position of the center of gravity. Thus, the rotation precision becomes stable and the precision of the cutting position is improved. When the cutting amount over the maximum cutting amount of the cutting apparatus is designated, by cutting the sheet bundle by the operating procedure in FIGS. 9A to 9F as mentioned above, the cut wastepaper can be miniaturized and the precision of the cutting position is improved.

The procedure for cutting each of the top portion and the foot portion twice has been described in the embodiment illustrated in FIGS. 9A to 9F. The cutting portion can be further divided and the cutting may be executed three or more times. In such a case, it is desirable to alternately cut the top portion and the foot portion.

The cutting apparatus equipped with the image forming apparatus and the glue coating bookbinding apparatus has been introduced in the foregoing embodiment. The cutting apparatus and cutting method according to the invention may be applied to other apparatuses such as saddle stitch bookbinding apparatus and staple bookbinding apparatus. Further, even if the invention is applied to an off-line cutting apparatus, a similar effect can be obtained.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2007-155168, filed Jun. 12, 2007, which is hereby incorporated by reference herein in its entirety.

What is claimed is:

1. A cutting apparatus for cutting a book bundle, comprising:
a book bundle rotating mechanism which rotates the book bundle and changes a cutting surface;
a book bundle moving mechanism which moves the book bundle in a direction of a cutting mechanism; and
the cutting mechanism which separately cuts the cutting surface of the book bundle a plurality of times and does not continuously cut a same surface excluding the cutting surface to be finally cut for the book bundle to be cut.

2. An apparatus according to claim 1, wherein in the case of cutting the book bundle by a cutting amount over a maximum cutting amount of the book bundle, the cutting mechanism separately cuts the same surface among a plurality of cutting surfaces a plurality of times.

3. An apparatus according to claim 1, wherein in the case of cutting a top portion and a foot portion of the book bundle, the cutting mechanism alternately cuts the top portion and the foot portion.

4. An apparatus according to claim 1, wherein the cutting apparatus is assembled into a bookbinding apparatus.

5. An apparatus according to claim 4, wherein the bookbinding apparatus is juxtaposed with an image forming apparatus.

6. A method of cutting a top portion and a toot portion of a book bundle whose front cover has been bound on one side, comprising:
rotating the book bundle and changing a cutting surface;
moving the book bundle in a direction of a cutting mechanism; and
separately cutting the cutting surface of the book bundle a plurality of times by the cutting mechanism not continuously cutting a same surface excluding the cutting surface to be finally cut for the book bundle to be cut.
